(19) United States
(12) Patent Application Publication
(10) Pub. No.: US 2013/0052498 A1
(43) Pub. Date: Feb. 28, 2013

(54) SECONDARY BATTERY

(71) Applicants: Jung-Yeop Han, Yongin-si (KR); Seung-Soo Jang, Yongin-si (KR)

(72) Inventors: Jung-Yeop Han, Yongin-si (KR); Seung-Soo Jang, Yongin-si (KR)

(73) Assignee: SAMSUNG SDI CO., LTD., Yongin-si (KR)

(21) Appl. No.: 13/539,718

(22) Filed: Jul. 2, 2012

(30) Foreign Application Priority Data
Aug. 24, 2011 (KR) 10-2011-0084826

(51) Int. Cl. H01M 10/48

(52) U.S. Cl. 429/90

(57) ABSTRACT

A secondary battery includes a battery unit, a thermistor for detecting a temperature of the battery unit, and a frame case for supporting the battery unit and the thermistor together, and including a thermistor accommodator having a concave shape and accommodating the thermistor. Accordingly, a way of installing the thermistor is improved.

### CLAIM OF PRIORITY

This application makes reference to, incorporates the same herein, and claims all benefits accruing under 35 U.S.C. §119 from an application earlier filed in the Korean Intellectual Property Office on the 24 Aug. 2011 and there duly assigned Serial No. 10-2011-0084826.

### BACKGROUND OF THE INVENTION

1. Field of the Invention

One or more embodiments of the present invention relate to a secondary battery.

2. Description of the Related Art

Secondary batteries are used in various technical fields throughout all industries due to their advantages. The secondary batteries are not only widely used as energy sources of mobile electronic devices, such as digital cameras, cellular phones, and laptops, but are also receiving attention as energy sources for hybrid electric cars etc., which are suggested as solutions to air pollution caused by internal combustion engines that use fossil fuels such as gasoline or diesel.

### SUMMARY OF THE INVENTION

One or more embodiments of the present invention include an improved secondary battery.

One or more embodiments of the present invention also include a secondary battery having an improved way of installing a thermistor for detecting a temperature.

Additional aspects will be set forth in part in the description which follows and, in part, will be apparent from the description, or may be learned by practice of the presented embodiments.

According to one or more embodiments of the present invention, a secondary battery includes a battery unit, a thermistor for detecting a temperature of the battery unit, and a frame case for supporting the battery unit and the thermistor together, and includes a thermistor accommodator having a concave shape and accommodating the thermistor.

The frame case may support the thermistor by embedding the thermistor in the thermistor accommodator, and may support the battery unit through a frame shape extending along an edge of the battery unit.

The battery unit may be disposed on the frame case to cover the thermistor in the thermistor accommodator.

The battery unit may include a battery cell and first and second lead tabs extending from the battery cell. The first and second lead tabs may
externally extend through a first edge portion of the frame case.

The thermistor accommodator may be formed at the first edge portion of the frame case.

The thermistor accommodator may be formed on the first edge portion of the frame case between first and second locations where the first and second lead tabs extend.

The frame case may include first and second frame cases that are assembled to face each other by disposing the battery unit and the thermistor between the first and second frame cases.

The thermistor accommodator may include a recess concavely formed on at least one side of the first and second frame cases.

The battery unit and the thermistor may mutually overlap each other between the first and second frame cases.

The battery unit may include a first edge portion where the first and second lead tabs extend respectively from first and second locations. The thermistor may be disposed on the first edge portion between the first and second locations while overlapping the battery unit.

The first and second frame cases may have a frame shape for holding and supporting the edge of the battery unit.

The first and second frame cases may include an opening portion exposing a center portion of the battery unit.

The secondary battery may further include a heat dissipating member disposed between the first and second frames.

The thermistor may be disposed on one surface of the battery unit and the heat dissipating member may be disposed on another surface of the battery unit.

The thermistor accommodator may be formed on the first frame case, the thermistor may be disposed between the first frame case and the battery unit, and the heat dissipating member may be disposed between the battery unit and the second frame case.

A fastening member may be formed on the first and second frame cases to combine the first and second frame cases together.

The fastening member may include a hook projection formed on a location where the first and second frame cases face each other, and a stopper in which the hook projection is inserted and held.

The thermistor accommodator may be formed on the hook projection.

According to one or more embodiments of the present invention, a secondary battery includes a battery unit, a thermistor for detecting a temperature of the battery unit, and first and second frame cases combined to face each other by disposing the battery unit and the thermistor between the first and second frame cases. The first frame case includes a thermistor accommodator having a concave shape to accommodate the thermistor.

First and second lead tabs of the battery unit may externally extend from between first edge portions of the first and second frame cases, and the thermistor accommodator may be formed on a first edge portion of the first frame case between first and second locations where the first and second lead tabs respectively extend.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded oblique view of a secondary battery constructed as an embodiment according to the principles of the present invention;

FIG. 2 is an oblique view of a part of the secondary battery of FIG. 1;

FIG. 3 is an oblique view of a battery unit constructed as an embodiment according to the principles of the present invention;

FIGS. 4 and 5 are oblique views of first and second frame cases constructed as an embodiment according to the principles of the present invention;

FIG. 6 is an oblique view of a secondary battery formed when the first and second frame cases are assembled together as an embodiment according to the principles of the present invention;

FIGS. 7 and 8 are oblique views of a secondary battery constructed as an embodiment according to the principles of the present invention for describing installation of a thermistor; and

FIG. 9 is a oblique view of a secondary battery module modularized as a plurality of secondary batteries are electrically bound to each other as an embodiment according to the principles of the present invention.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

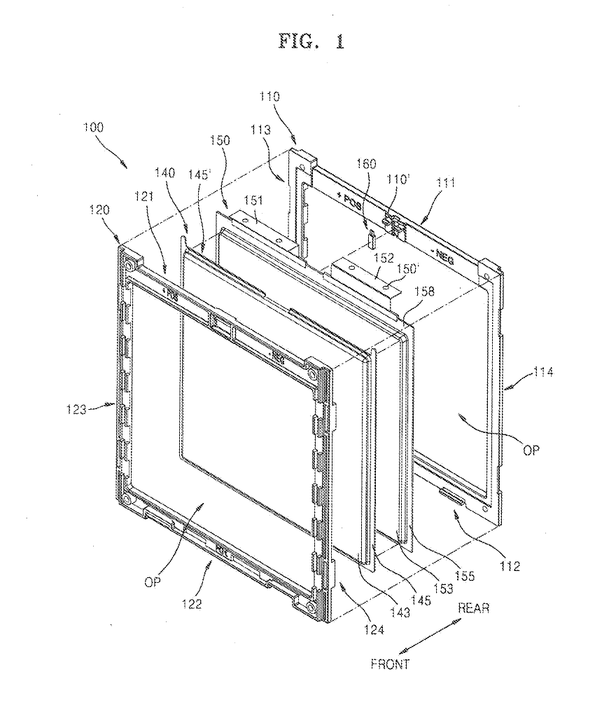

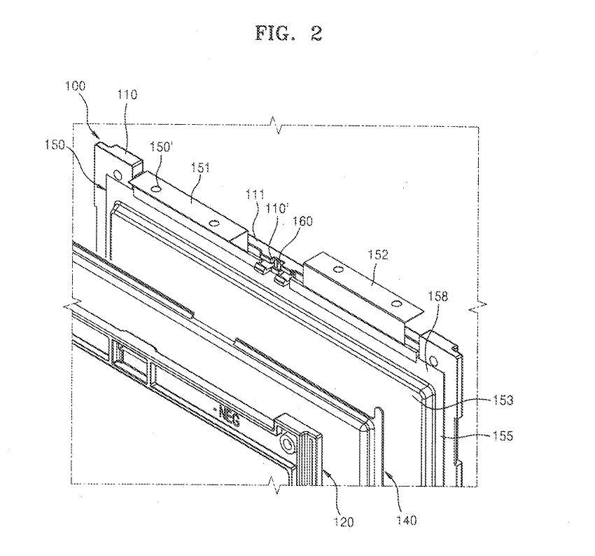

FIG. 1 is an exploded oblique view of a secondary battery 100 constructed as an embodiment according to the principles of the present invention, and FIG. 2 is an oblique view of a part of the secondary battery 100 of FIG. 1.

Referring to FIGS. 1 and 2, the secondary battery 100 includes a battery unit 150, and first and second frame cases 110 and 120 for supporting the battery unit 150. As will be described later, the first and second frame cases 110 and 120 may support, together with the battery unit 150, a thermistor 160 for detecting a temperature of the battery unit 150.

For example, the first and second frame cases 110 and 120 includes a thermistor accommodator 110′ having a concave shape to accommodate the thermistor 160, and may support the thermistor 160 by embedding the thermistor 160 by using the thermistor accommodator 110′. The first and second frame cases 110 and 120 may support the battery unit 150 through a frame shape extending along an edge of the battery unit 150. For example, the battery unit 150, more particularly, a first edge portion 158 of the battery unit 150, may be fixed between the first and second frame cases 110 and 120 to cover the thermistor 160 disposed in the thermistor accommodator 110′.

The battery unit 150 is structurally supported by the first and second frame cases 110 and 120. The battery unit 150 and the first and second frame cases 110 and 120 may he assembled to face each other. For example, the first and second frame cases 110 and 120 may be assembled to face each other across the battery unit 150.

The first and second frame cases 110 and 120 may have a quadrangular frame shape having an opening portion OP in the center. For example, the first and second frame cases 110 and 120 may have a square or approximately square edge shape.

The first and second frame cases 110 and 120 constricts a flange unit 155 of the battery unit 150 while surrounding the battery unit 150 so as to strongly fix the battery unit 150, and a body 153 of the battery unit 150 is exposed between the first and second frame cases 110 and 120 through the opening portion OP. A center portion of the battery unit 150 is exposed through the opening portion OP of the first and second frame cases 110 and 120. In other words, the battery unit 150 is installed while being exposed between the first and second frame cases 110 and 120, and heat radiation may be accelerated by exposing the body 153 where heat of the battery unit 150 is concentrated between the first and second frame cases 110 and 120.

For example, the flange unit 155 of the battery unit 150 constricted between the first and second frame cases 110 and 120 may correspond to an edge of the battery unit 150, wherein an extra exterior material sealing an electrode assembly (not shown) extends outward. Here, the electrode assembly is not damaged even if the flange unit 155 of the battery unit 150 is pressed between the first and second frame cases 110 and 120. Meanwhile, heat radiation may be accelerated by exposing the body 153 of the battery unit 150 including the electrode assembly between the first and second frame cases 110 and 120. However, as will be described later, since the battery unit 150 may further include a heat dissipating member 140 between the first and second frame cases 110 and 120, the body 153 of the battery unit 150 may not be exposed to the outside of the secondary battery 100.

The first and second frame cases 110 and 120 may have quadrangular frame shapes respectively including first through fourth edge portions 111 through 114 and 121 through 124. In detail, the first and second frame cases 110 and 120 may include the first edge portions 111 and 121 at the top where first and second lead tabs 151 and 152 of the battery unit 150 are extended, the second edge portions 112 and 122 at the bottom parallel to the first edge portion 111, and the third and fourth edge portions 113 and 114 and 123 and 124 to the left and right parallel to each other and perpendicular to the first and second edge portions 111 and 112 and 121 and 122. For example, the first edge portions 111 and 121 of the first and second frame cases 110 and 120 are formed at a side where the first and second lead tabs 151 and 152 of the battery unit 150 are extended, and the first and second lead tabs 151 and 152 of the battery unit 150 may be extended outside the first and second frame cases 110 and 120 through the first edge portions 111 and 121.

The first and second lead tabs 151 and 152 may extend from between the first and second frame cases 110 and 120 that are adhered to each other while facing each other. In order to obtain insulation with the first and second lead tabs 151 and 152, the first and second frame case 110 and 120 my be formed of an insulating resin material, for example, a polymer resin material such as poly(p-phenylene sulfide) (PPS).

Along with the battery unit 150, the heat dissipating member 140 may be further disposed between the first and second frame cases 110 and 120. The heat dissipating member 140 may have an approximate plate shape covering one surface of the battery unit 150. The heat dissipating member 140 may be formed of a metal having excellent thermal conductivity, such as aluminum, iron, or copper.

The heat dissipating member 140 may include a heat-dissipation portion 143 concavely formed to cover the body 153 that forms a thick portion of the battery unit 150, and a fixing unit 145 extending from the heat-dissipation portion 143 to be held and supported with the flange unit 155 of the battery unit 150 between the first and second frame cases 110 and 120. The heat dissipating member 140 may accelerate heat radiation by covering and adhering to the body 153 of the battery unit 150 through the heat-dissipation portion 143, and may have a strong fixed location by being held and supported between the first and second frame cases 110 and 120 through the fixing unit 145.

A cut portion 145′ may be disposed at the top of the fixing unit 145 where the first and second lead tabs 151 and 152 are extended, from among the heat dissipating member 140. The cut portion 145′ may be formed by concavely digging into the fixing unit 145, so as to remove a portion of the fixing unit 145. Due to material characteristics of the heat dissipating member 140 that is often formed of a metal having excellent thermal conductivity, the cut portion 145′ may be formed at a part of the heat dissipating member 140 so as to avoid electric interference with the first and second lead tabs 151 and 152.

Aside from dissipating heat of the battery unit 150, the heat dissipating member 140 may also suppress thermal expansion of the battery unit 150. In other words, the heat dissipating member 140 covering one surface of the battery unit 150 suppresses a swelling phenomenon of the battery unit 150, thereby preventing deterioration of electric characteristics of the battery unit 150. In a secondary battery module that is modularized as the plurality of secondary batteries 100 are bound to each other, the secondary batteries 100 are stacked to overlap each other. Here, the heat dissipating member 140 may suppress the swelling phenomenon to uniformly maintain an interval between the neighboring secondary batteries 100 and may prevent thermal runaway due to thermal interference between the neighboring secondary batteries 100. As shown in FIG. 1, the heat dissipating member 140 is disposed on a front surface of the battery unit 150, while the thermistor 160 is disposed on a rear surface of the battery unit 150. Also, as shown in FIG. 1, the thermistor accommodator 110′ is formed on the first frame case 110, the thermistor 160 is disposed between the first frame case 110 and the battery unit 150, and the heat dissipating member 140 is disposed between the battery unit 150 and the second frame case 120.

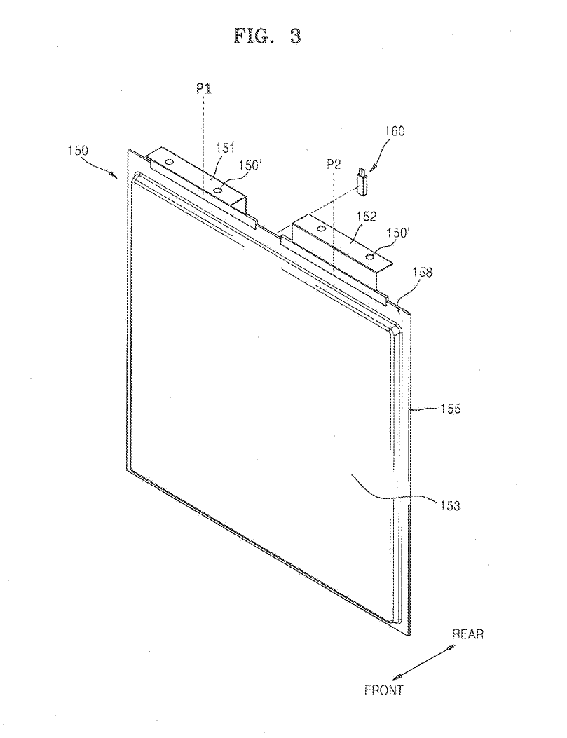

FIG. 3 is an oblique view of the battery unit 150 constructed as an embodiment according to the principles of the present invention.

Referring to FIG. 3, the battery unit 150 may be a lithium-ion battery. The battery unit 150 includes a battery cell and the first and second lead tabs 151 and 152 electrically connected to the battery cell and extending from the battery cell.

The battery cell includes the body 153 forming a relatively thick portion by including the electrode assembly, and the flange unit 155 excluding the electrode assembly and forming a relatively thin portion by including an extra exterior material sealing the electrode assembly.

The body 153 occupies most areas of the battery cell, and the flange unit 155 may correspond to an edge where the extra exterior material is extended outward. The battery cell is fixed between the first and second frame cases 110 and 120 having an approximate quadrangular edge shape assembled to face each other. Here, the flange unit 155 may be held and supported between the first and second frame cases 110 and 120. However, alternatively, the first and second frame cases 110 and 120 may fix the battery cell by using other portion of the battery cell according to a detailed changeable shape of the battery cell.

The first and second lead tabs 151 and 152 form an external interconnection of the battery cell, and extend from the battery cell to externally induce a current from the battery cell. The first and second lead tabs 151 and 152 may be formed of a metal having excellent conductivity, such as nickel, aluminum, or copper. The first and second lead tabs 151 and 152 may have different polarities, and may be respectively electrically connected to a positive plate (not shown) and a negative plate (not shown) of the battery cell. For example, the first lead tab 151 may correspond to an positive tab and the second lead tab 152 may correspond to a negative tab.

The first and second lead tabs 151 and 152 may extend from the first edge portion 158 of the battery unit 150, and may extend from different first and second locations P1 and P2 along the first edge portions 158. The thermistor accommodator 110′ may be formed at the first edge portion 158 of the battery unit 150, so that the thermistor 160 may be disposed on the first edge portion 158 of the battery unit 150. In detail, the thermistor 160 is disposed on the first edge portion 158 between the first and second locations P1 and P2 where the first and second lead tabs 151 and 152 extend. The thermistor 160 and the battery unit 150 (in detail, the first edge portion 158 of the battery unit 150) may be adhered to each other between the first and second frame cases 110 and 120 facing each other according to a fastening force of the first and second frame cases 110 and 120. Here, the thermistor 160 may be disposed on the first edge portion 158 of the battery unit 150 while overlapping the battery unit 150 between the first and second locations P1 and P2. Charging and discharging currents may be concentrated and thus heat may be concentrated in the first and second lead tabs 151 and 152. Accordingly, a heat dissipating state or operating state of the battery unit 150 may be checked by detecting a temperature of a center location between the first and second lead tabs 151 and 152.

Referring to FIGS. 1 through 3, the first and second lead tabs 151 and 152 having different polarities may be bent in different directions. For example, in the secondary battery module modularized by electrically binding the secondary batteries 100, the first lead tab 151 may bend in a frontward direction and the second lead tab 152 may bend in a rearward direction along front and rear directions in which the secondary batteries 100 are arranged.

In the secondary battery module, the secondary batteries 100 may be disposed to overlap each other in parallel, or alternately may be disposed to be connected in series. In other words, the neighboring secondary batteries 100 may be alternately disposed such that right and left of the first and second lead tabs 151 and 152 having different polarities are switched, and the first and second lead tabs 151 and 152 bent in facing directions may be connected according to pairs of the neighboring secondary batteries 100, thereby electrically connecting the secondary batteries 100.

In order to electrically connect the secondary batteries 100, a fastening hole 150′ may be formed on the first and second lead tabs 151 and 152. For example, the first and second lead tabs 151 and 152 of the neighboring secondary batteries 100 may be disposed to overlap each other, and the neighboring secondary batteries 100 may be electrically connected to each other by a fastening member (not shown) inserted through the overlapping first and second lead tabs 151 and 152. For example, a pair of fastening holes 150′ may be formed on each of the first and second lead tabs 151 and 152.

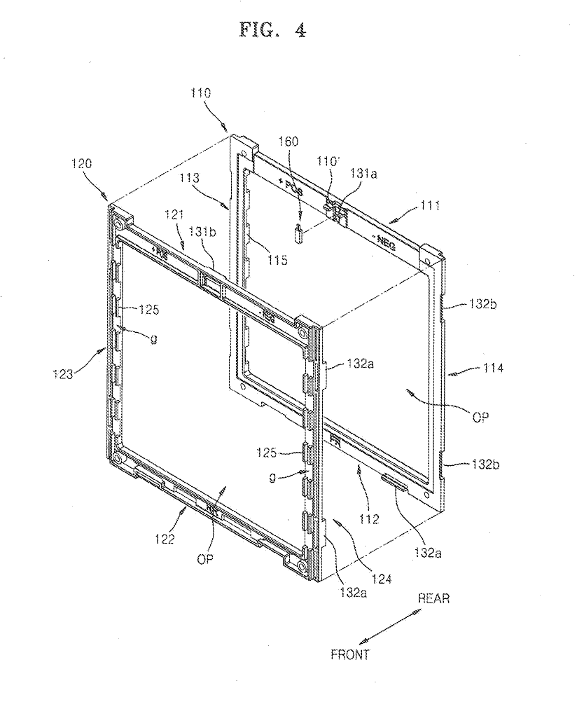

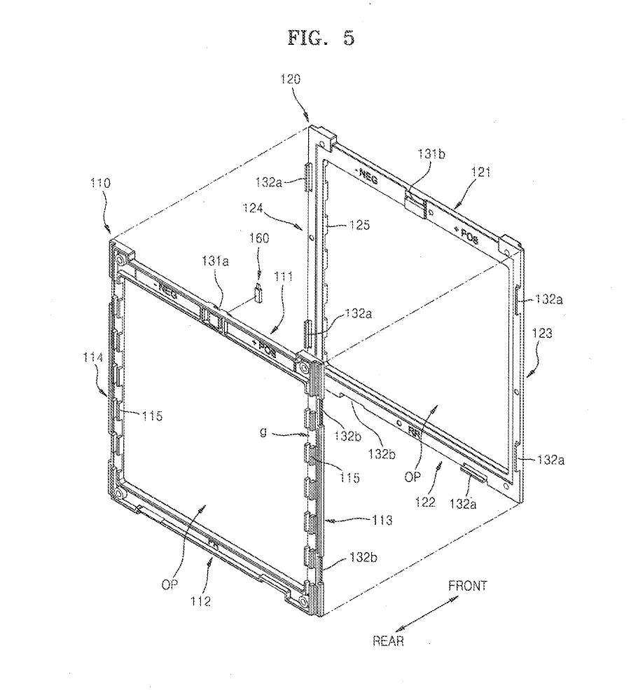

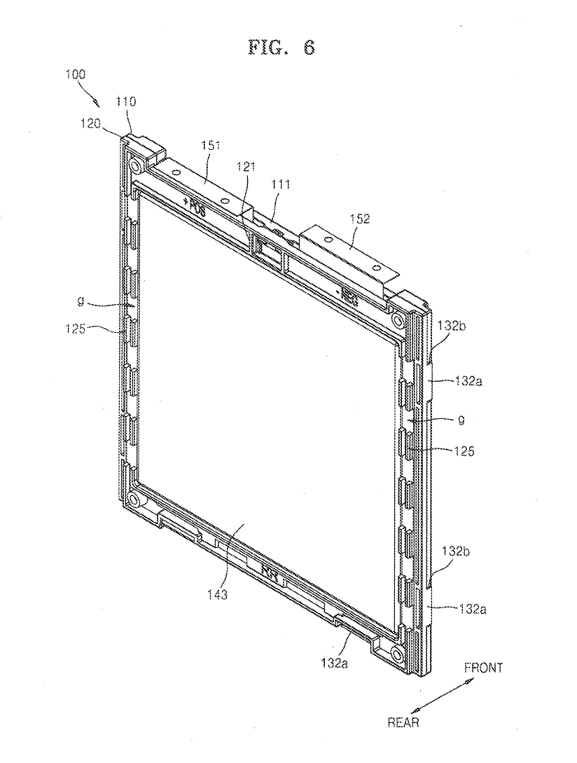

FIG. 4 is an oblique view of the first and second frame cases 110 and 120 constructed as an embodiment according to the principles of the present invention, FIG. 5 is an oblique view of the first and second frame cases 110 and 120 of FIG. 4 reversed by being rotated by 180°, and FIG. 6 is an oblique view of the secondary battery 100 formed as the first and second frame cases 110 and 120 are assembled together as an embodiment according to the principles of the present invention.

Referring to FIGS. 4 through 6, the first and second frame cases 110 and 120 may be combined with each other by using fastening members by disposing the battery unit 150 therebetween, and the battery unit 150 may be supported by being restricted between the first and second frame cases 110 and 120. The fastening members may be mechanical fastening units complementarily formed at corresponding locations of the first and second frame cases 110 and 120. For example, the fastening members may include a hook combining structure, and in detail, may include hook projections 131a and 132a having a hook shape at any one of the first and second frame cases 110 and 120, and stoppers 131b and 132b into which the hook projections 131a and 132a are inserted at another of the first and second frame cases 110 and 120. The hook projections 131a and 132a may be formed on a location where the first and second frame cases 110 and 120 face each other. For example, the stoppers 131b and 132b may include a groove concavely dented or a through hole to accommodate the hook projections 131a and 132a.

The fastening members may be formed in at least one location along the first and second frame cases 110 and 120, or in several locations to strongly press and fix the battery unit 150. The fastening members formed in several locations may provide a uniform fastening force along the edge of the battery unit 150. For example, the fastening members may be formed throughout the first through fourth edge portions 111 through 114 and 121 through 124. Each of the fastening members includes a pair of a hook projection and stopper at facing locations.

For example, the fastening member formed in the first edge portions 111 and 121 includes the hook projection 131 a having a hook shape protruding from the first frame case 110 to the second frame case 120, and the stopper 131b formed on the second frame case 120 facing the hook projection 131a. As the first and second frame cases 110 and 120 are adhered to each other while facing each other, the hook projection 131a may be bound to the stopper 131b by being deformed to accommodate the stopper 131b and then elastically restored. For example, the hook projection 131a formed on the first frame case 110 may be cut from a body of the first frame case 110, and may flexibly deform through such a cut structure to accommodate the stopper 131b. Accordingly, a fastening operation of the first and second frame cases 110 and 120 may be more easily performed.

By using the fastening members formed on the first and second frame cases 110 and 120, a separate assembling structure, such as a tape or a screw, is not required, and thus an assembly operation of the first and second frame cases 110 and 120 is simplified and has improved operability.

Spacers 115 and 125 may be formed on the first and second frame cases 110 and 120. The spacers 115 and 125 may extend along the first and second frame cases 110 and 120 having a quadrangular frame shape, and the plurality of spacers 115 and 125 may be arranged at predetermined gaps along an extending direction of the first and second frame cases 110 and 120. The spacers 115 and 125 may be formed together on the first and second frame cases 110 and 120, and may be formed on an outer surface of the first and second frame cases 110 and 120, i.e., on an outer surface opposite to the facing surfaces. The spacers 115 and 125 may be used as an air passage between the neighboring secondary batteries 100.

In detail, in the secondary battery module modularized by electrically combining the secondary batteries 100 by using the secondary battery 100 of FIG. 6 as one assembly unit, the spacers 115 and 125 protruding from the neighboring secondary batteries 100 in a stacked direction may provide an air passage. For example, the air passage may be formed through a predetermined gap g between the spacers 115 and 125 as the spacers 115 and 125 of the neighboring secondary batteries 100 contact each other, and heat of the secondary battery 100 is discharged through the air passage, thereby accelerating heat radiation of the secondary battery 100. For example, low temperature external air flowing in through the air passage may transfer heat by directly contacting the battery unit 150 or the heat dissipating member 140 exposed through the opening portion OP of the first and second frame cases 110 and 120, thereby accelerating heat radiation of the battery unit 150.

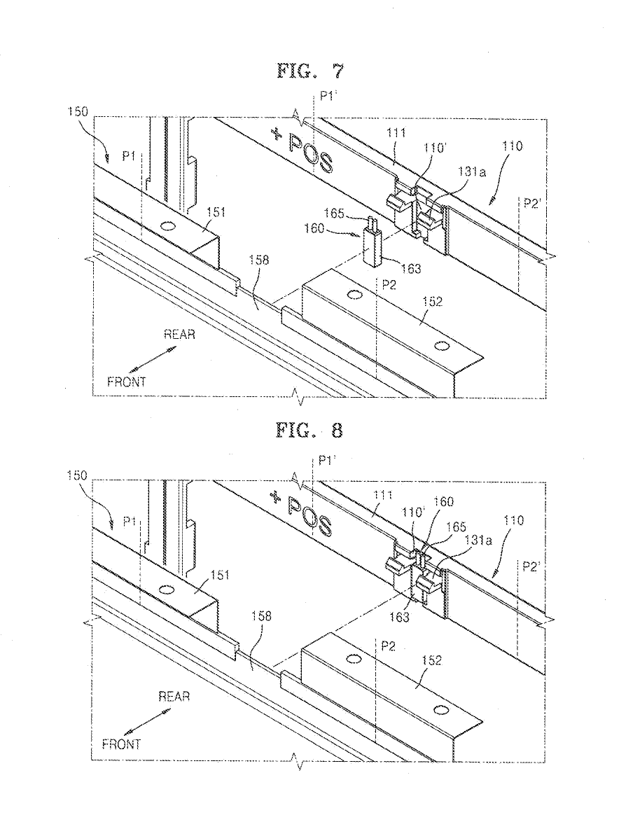

FIGS. 7 and 8 are perspective views for describing installation of the thermistor 160.

Referring to FIGS. 1, 7, and 8 together, the secondary battery 100 may include the thermistor 160 for measuring a temperature of the battery unit 150. The first and second frame cases 110 and 120 may include the thermistor accommodator 110′ for accommodating the thermistor 160. The thermistor accommodator 110′ may have a concave shape to suitably accommodate the thermistor 160. The thermistor 160 may be embedded in the thermistor accommodator 110′ formed on one of the first and second frame cases 110 and 120 adhered to face each other, thereby being adhered to the battery unit 150. For example, the thermistor accommodator 110′ may be formed on the first frame case 110 and may be a concave recess.

The first and second frame cases 110 and 120 are assembled to face each other while the thermistor 160 and the battery unit 150 are disposed therebetween. Here, the thermistor 160 and the battery unit 150 (more particularly, the first edge portion 158 of the battery unit 150) are disposed to overlap each other, and may be adhered to each other according to a fastened state of the first and second frame cases 110 and 120. In other words, the thermistor 160 and the battery unit 150 (in detail, the first edge portion 158 of the battery unit 150) may be adhered to each other as the battery unit 150 (in detail, the first edge portion 158 of the battery unit 150) is held and supported between the first frame case including the thermistor 160 and the second frame case 120.

According to another embodiment, the thermistor accommodator 110′ may be formed at the first and second frame cases 110 and 120 assembled to face each other. For example, the first and second frame cases adhered to each other may include a pair of concave recesses at facing locations, and an accommodating space of the thermistor 160 may be prepared by adhering the first and second frame cases 110 and 120. Here, the accommodating space of the thermistor 160 may be defined by the concave recesses formed at the first and second frame cases 110 and 120.

The thermistor accommodator 110′ may be prepared in the first edge portion 111 of the first frame case 110, and in detail, in an approximate center location of the first edge portion 111. The first and second lead tabs 151 and 152 of the battery unit 150 extend to the outside of the first frame case 110 through the first edge portion 111 of the first frame case 110, and the thermistor accommodator 110′ may be prepared on such a first edge portion 111 of the first frame case 110.

The battery unit 150 (more particularly, the first edge portion 158 of the battery unit 150) is held and supported between the first and second frame cases 110 and 120, and the battery unit 150 and the first edge portion 111 of the first frame case 110 may be adhered to each other according to the fastening force between the first and second frame cases 110 and 120. The first edge portion 111 of the first frame case 110 may be adhered to the first edge portion 158 of the battery unit 150, and the thermistor 160 in the first edge portion 111 of the first frame case 110 may be adhered to the first edge portion 158 of the battery unit 150 from which the first and second lead tabs 151 and 152 extend, and thus temperatures of the first and second lead tabs 151 and 152 where heat generation is concentrated may be precisely measured.

The thermistor 160 is adhered to a center location between the first and second locations P1 and P2 where the first and second lead tabs 151 and 152 are extended from among the first edge portion 158 of the battery unit 150, and may measure a temperature of the center location. In other words, the thermistor accommodator 110′ may be formed in a center location between first and second locations P1′ and P2′ where the first and second lead tabs 151 and 152 extend from among the first edge portion 111 of the first frame case 110.

The first and second lead tabs 151 and 152 form a path of charging and discharging currents of the secondary battery 100, wherein the discharging current generated in the battery unit 150 is supplied to an external circuit (not shown) through the first and second lead tabs 151 and 152, and the charging current from an external power supply apparatus (not shown) is input to the battery unit 150 through the first and second lead tabs 151 and 152. Accordingly, the charging and discharging currents are concentrated at the first and second lead tabs 151 and 152, and thus heat may be concentrated in the first and second lead tabs 151 and 152. Here, by detecting the temperature of the first or second lead tab 151 or 152, an abnormal operation may be determined and charging and discharging operations may be controlled.

The thermistor 160 converts information about the measured temperature into an electric signal, and transmits the electric signal to a circuit unit (not shown), such as a battery management system (BMS). The thermistor 160 may be realized as a resistance temperature sensor whose electric resistance is changed according to temperature so as to generate a voltage signal corresponding to a measured temperature. The thermistor 160 may include a thermistor chip 163 including a variable resistor, and a wiring unit 165 extending from the thermistor chip 163 to receive driving power and transmitting the electric signal to the circuit unit, such as the BMS.

For example, the BMS may receive the electric signal of the thermistor 160 to determine a current state of the secondary battery 100, and control the charging and discharging operations of the secondary battery 100.

Instead of forming an isolated space from the outside of the first frame case 110, the thermistor accommodator 110′ may form an open space communicating with the outside of the first frame case 110 to externally extend the wiring unit 165 extending from the thermistor chip 163. In other words, while fastening the first and second frame cases 110 and 120, the thermistor accommodator 110′ provides an accommodation space for the thermistor chip 163, wherein at least one side of the accommodation space is opened toward the first frame case 110 so that the wiring unit 165 extend.

The thermistor accommodator 110′ may be formed on the hook projection 131a of the fastening members. In detail, the thermistor accommodator 110′ may be formed on the hook projection 131a cut from the body of the first frame case 110, and may provide the accommodation space accommodating the thermistor chip 163. The thermistor accommodator 110′ may be extended from the hook projection 131a to the outside of the first frame case 110, and may accommodate the wiring unit 165 extending from the thermistor chip 163.

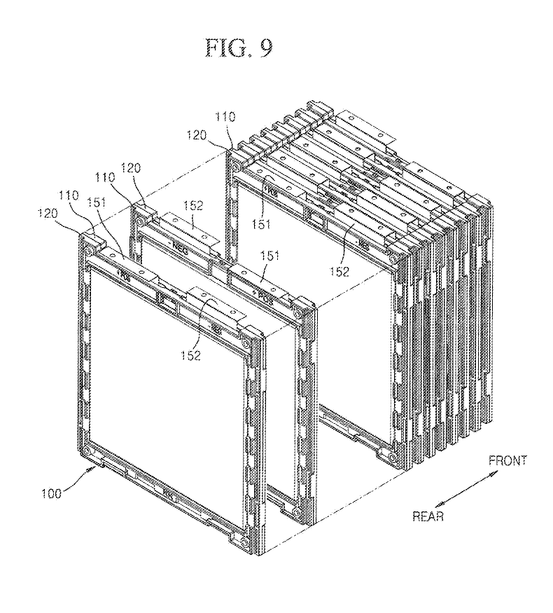

FIG. 9 is an oblique view of a secondary battery module modularized as a plurality of the secondary batteries 100 electrically bound to each other as an embodiment according to the principles of the present invention. For example, in order to provide a secondary battery module having high output and high capacity, the secondary batteries 100 are stacked in parallel along one direction, and are electrically bound to each other.

As shown in FIG. 9, the first and second lead tabs 151 and 152 extending from each of the secondary batteries 100 are bent in opposite directions along the front and rear directions of the secondary batteries 100. Then, the first and second lead tabs 151 and 152 bent from one secondary battery 100 overlap the first and second lead tabs 151 and 152 bent from the neighboring secondary battery 100.

For example, the first lead tab 151 bent in a front direction from one secondary battery 100 may overlap the second lead tab 152 bent in a rear direction from the front secondary battery 100, and such overlapping first and second lead tabs 151 and 152 may electrically bind the one secondary battery 100 and the front secondary battery 100. The first and second lead tabs 151 and 152 may have different polarities, and the neighboring batteries 100 may be connected in series as the first and second lead tabs 151 and 152 having different polarities contact each other.

Similarly, the second lead tab 152 bent in a rear direction from one secondary battery 100 may overlap the first lead tab 151 bent in a front direction from the rear secondary battery 100, and the one secondary battery 100 and the rear secondary battery 100 may be connected in series via such overlapping first and second lead tabs 151 and 152.

In the secondary battery module, the secondary batteries 100 may be alternately arranged to be connected in series. In other words, right and left of the first and second lead tabs 151 and 152 of the neighboring secondary batteries 100 alternate. However, the secondary batteries 100 of the secondary battery module may be connected in parallel, or in a combination of in series and parallel.

As described above, according to one or more of the above embodiments of the present invention, a way of installing of a thermistor is improved by forming a thermistor for detecting a temperature on a frame case supporting a battery unit.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A secondary battery, comprising:
a battery unit;
a thermistor for detecting a temperature of the battery unit; and
a frame case for supporting the battery unit and the thermistor together, and comprising a thermistor accommodator having a concave shape and accommodating the thermistor.

2. The secondary battery of claim 1, wherein the frame case supports the thermistor by embedding the thermistor in the thermistor accommodator, and supports the battery unit through a frame shape extending along an edge of the battery unit.

3. The secondary battery of claim 1, wherein the battery unit is disposed on the frame case to cover the thermistor in the thermistor accommodator.

4. The secondary battery of claim 1, wherein the battery unit comprises a battery cell and first and second lead tabs extending from the battery cell, wherein the first and second lead tabs externally extend through a first edge portion of the frame case.

5. The secondary battery of claim 4, wherein the thermistor accommodator is formed at the first edge portion of the frame case.

6. The second battery of claim 4, wherein the thermistor accommodator is formed on the first edge portion of the frame case between first and second locations where the first and second lead tabs extend.

7. The secondary battery of claim 1, wherein the frame case comprises first and second frame cases that are assembled to face each other by disposing the battery unit and the thermistor between the first and second frame cases.

8. The secondary battery of claim 7, wherein the thermistor accommodator comprises a recess concavely formed on at least one side of the first and second frame cases.

9. The secondary battery of claim 7, wherein the battery unit and the thermistor mutually overlap each other between the first and second frame cases.

10. The secondary battery of claim 9, wherein the battery unit comprises a first edge portion where first and second lead tabs extend respectively from first and second locations, wherein the thermistor is disposed on the first edge portion of the battery unit between the first and second locations while overlapping the battery unit.

11. The secondary battery of claim 7, wherein the first and second frame cases have a frame shape for holding and supporting the edge of the battery unit.

12. The secondary battery of claim 11, wherein the first and second frame cases comprise an opening portion exposing a center portion of the battery unit.

13. The secondary battery of claim 7, further comprising a heat dissipating member disposed between the first and second frames.

14. The secondary battery of claim 13, wherein the thermistor is disposed on one surface of the battery unit and the heat dissipating member is disposed on another surface of the battery unit.

15. The secondary battery of claim 14, wherein the thermistor accommodator is formed on the first frame case, the thermistor is disposed between the first frame case and the battery unit, and the heat dissipating member is disposed between the battery unit and the second frame case.

16. The secondary battery of claim 7, wherein a fastening member is formed on the first and second frame cases to combine the first and second frame cases together.

17. The secondary battery of claim 16, wherein the fastening member comprises:
a hook projection formed on a location where the first and second frame cases face each other; and
a stopper in which the hook projection is inserted and held.

18. The secondary battery of claim 17, wherein the thermistor accommodator is formed on the hook projection.

19. A secondary battery comprising:
a battery unit;
a thermistor for detecting a temperature of the battery unit; and
first and second frame cases combined to face each other by disposing the battery unit and the thermistor between the first and second frame cases,
the first frame case comprises a thermistor accommodator having a concave shape to accommodate the thermistor.

20. The secondary battery of claim 19, wherein first and second lead tabs of the battery unit externally extend from between first edge portions of the first and second frame cases, wherein the thermistor accommodator is formed on the first edge portion of the first frame case between first and second locations where the first and second lead tabs respectively extend.
